(19) United States
(12) Patent Application Publication
(10) Pub. No.: US 2026/0088037 A1
(43) Pub. Date: Mar. 26, 2026

(54) SYSTEM AND METHOD FOR AUDIO TRANSIENT DETECTION AND PROCESSING IN THE FREQUENCY DOMAIN

(71) Applicant: ZYNAPTIQ GMBH, Hannover (DE)

(72) Inventors: Henrik Jürgens, Hannover (DE); Denis Gökdag, Hannover (DE)

(21) Appl. No.: 19/341,434

(22) Filed: Sep. 26, 2025

Related U.S. Application Data
(60) Provisional application No. 63/699,214, filed on Sep. 26, 2024.

(51) Int. Cl. G10L 21/0232; G10L 21/0264; G10L 21/0316; G10L 25/18

(52) U.S. Cl. CPC G10L 21/0232; G10L 21/0264; G10L 21/0316; G10L 25/18

(57) ABSTRACT

In one embodiment, a computer-implemented method for detecting audio transients in frequency domain representations is disclosed. The method includes: transforming audio data into a frequency domain representation using a Short-Time Fourier Transform to generate a plurality of frequency bins across a plurality of audio frames; determining instantaneous frequencies for the plurality of frequency bins using phase information from the frequency domain representation; determining a noisiness value for a spectral peak of a frequency bin of the plurality of frequency bins by determining a minimum absolute difference between instantaneous frequencies of adjacent frequency bins within the spectral peak; determining that the spectral peak contains a transient component when the noisiness value exceeds a threshold value; clustering the transient component with other detected transient components based on spectral or temporal proximity; and processing the cluster of transient components.

### CROSS-REFERENCE TO RELATED APPLICATIONS

This application claims priority to U.S. Application No. 63/699,214, titled “METHOD FOR TRANSIENT DETECTION AND PROCESSING IN THE FREQUENCY DOMAIN, filed Sep. 26, 2024, which is hereby incorporated by reference herein in its entirety.

### FIELD OF INVENTION

The present disclosure relates to audio signal processing in the frequency domain, and more particularly to a method for detecting and processing audio transients using phase information analysis in Short-Time Fourier Transform representations to improve signal quality and preserve transient characteristics during frequency domain modifications.

### BACKGROUND

Audio signal processing in the frequency domain is a common technique in modern digital audio applications, including pitch shifting, time stretching, audio enhancement, noise reduction, and various creative audio effects. However, frequency domain audio processing presents inherent challenges when dealing with real-world audio signals that contain both harmonic content and transient events. Harmonic content, such as sustained musical tones or steady-state sounds, can be effectively represented and processed using sinusoidal models in the frequency domain. In contrast, transient events-such as percussive notes, speech consonants, or other short-duration, high-energy audio events-do not conform well to sinusoidal representations and can suffer degradation when processed using conventional frequency domain techniques.

When audio signals containing transients are processed without proper identification and handling of these transient components, the resulting audio often exhibits artifacts such as pre-ringing, post-ringing, or a “washed out” quality that diminishes the perceived clarity and impact of the original signal. These artifacts arise because transient events, which are characterized by rapid changes in both amplitude and spectral content, are poorly modeled by the sinusoidal basis functions underlying frequency domain transforms.

### BRIEF SUMMARY

In one embodiment, a computer-implemented method for processing audio transients is disclosed. The method includes performing, via a processor, a Short-Term Fourier Transform (STFT) on audio data to generate a frequency-domain representation of the audio data, the frequency domain representation including: an audio frame defining a time range in the audio data; and a first frequency bin in the audio frame, wherein the first frequency bin defines a first frequency range of the audio data in the audio frame; determining, via the processor, a first instantaneous frequency of the first frequency bin; determining, via the processor, a first audio transient by comparing the first instantaneous frequency with one or more instantaneous frequencies of one or more frequency bins to determine that the first instantaneous frequency is asynchronous with the one or more instantaneous frequencies; clustering, via the processor, the first audio transient with one or more audio transients of the audio data; and processing, via the processor, the cluster of audio transients.

In another embodiment, a computer-implemented method for detecting audio transients in frequency domain representations is disclosed. The method includes: transforming, via a processor, audio data into a frequency domain representation using a Short-Time Fourier Transform to generate a plurality of frequency bins across a plurality of audio frames; determining, via the processor, instantaneous frequencies for the plurality of frequency bins using phase information from the frequency domain representation; determining, via the processor, a noisiness value for a spectral peak of a frequency bin of the plurality of frequency bins by determining a minimum absolute difference between instantaneous frequencies of adjacent frequency bins within the spectral peak; determining, via the processor, that the spectral peak contains a transient component when the noisiness value exceeds a threshold value; clustering, via the processor, the transient component with other detected transient components based on spectral or temporal proximity; and processing, via the processor, the cluster of transient components.

In another embodiment, an audio processing system, is disclosed. The system includes: a processor; and memory storing instructions that, when executed by the processor, cause the processor to: perform a Short-Time Fourier Transform on audio data to generate frequency bins within audio frames; calculate instantaneous frequencies for the frequency bins using phase differences between consecutive audio frames; identify transient components by detecting asynchronous behavior in the instantaneous frequencies across adjacent frequency bins; cluster the identified transient components into groups based on similarity criteria; and apply targeted processing operations to the clustered transient components separately from non-transient spectral content.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a schematic illustrating an example configuration of an audio processing system.

FIG. 2 is a flow diagram of a method for detecting audio transients and processing audio with the audio processing system of FIG. 1.

FIG. 3A illustrates an example time-domain representations of an audio signal as referenced in the method of FIG. 2.

FIG. 3B illustrates an example time-domain representations of an audio signal as referenced in the method of FIG. 2.

FIG. 3C illustrates an example time-domain representations of an audio signal as referenced in the method of FIG. 2.

FIG. 4A illustrates an example Short-Time Fourier Transform magnitude of an audio signal as referenced in the method of FIG. 2.

FIG. 4B illustrates an example Short-Time Fourier Transform magnitude of an audio signal as referenced in the method of FIG. 2.

FIG. 4C illustrates an example Short-Time Fourier Transform magnitude of an audio signal as referenced in the method of FIG. 2.

FIG. 5A illustrates an example instantaneous frequency measurement of an audio signal as referenced in the method of FIG. 2.

FIG. 5B illustrates an example instantaneous frequency measurement of an audio signal as referenced in the method of FIG. 2.

FIG. 5C illustrates an example instantaneous frequency measurement of an audio signal as referenced in the method of FIG. 2.

FIG. 6A illustrates an example instantaneous frequency measurement of an audio signal as referenced in the method of FIG. 2.

FIG. 6B illustrates an example instantaneous frequency measurement of an audio signal as referenced in the method of FIG. 2.

FIG. 6C illustrates an example instantaneous frequency measurement of an audio signal as referenced in the method of FIG. 2.

FIG. 7 is a block diagram of an example computer system suitable for use with the audio processing system of FIG. 1.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Audio processing in the frequency domain provides a framework for analyzing and manipulating audio signals by transforming time-domain representations into frequency-domain representations. This transformation enables detailed examination of spectral content and facilitates various audio processing operations such as pitch shifting, time stretching, and noise reduction. Traditional frequency domain processing methods often encounter challenges when handling transient audio components, which are short-duration, high-energy events such as percussive sounds or sudden acoustic changes. These transient components may become distorted or exhibit unwanted artifacts when processed using conventional approaches that treat all spectral content uniformly.

The disclosed approach addresses these challenges through enhanced transient detection and processing techniques that leverage phase information analysis within frequency domain representations. An audio processing system may use a Short-Term Fourier Transform (STFT) to split an audio signal into overlapping frames with a window function applied. The STFT provides a time-frequency representation that captures both temporal and spectral characteristics of the audio signal, enabling more precise analysis of transient events. By examining phase relationships and instantaneous frequency characteristics across frequency bins, the system may distinguish between sinusoidal components and transient components within the spectral representation.

The detection methodology focuses on identifying asynchronicity in instantaneous frequencies across frequency bins, which serves as an indicator of transient content. Sinusoidal components typically exhibit synchronized phase relationships across adjacent frequency bins, while transient components demonstrate irregular phase behavior that deviates from sinusoidal patterns. This phase-based analysis may be combined with magnitude-based detection techniques to provide robust transient identification. Once transients are detected, the system may cluster related transient components together, enabling targeted processing that preserves the acoustic characteristics of transient events while allowing separate treatment of sinusoidal components.

The clustering and separate processing of transient components enables improved audio quality in various applications. By treating transient and sinusoidal components differently, the system may avoid the “washed out” sound quality that often results from uniform frequency domain processing. The approach allows for optimization of processing parameters for different types of audio content, maintaining the percussive character of transient sounds while enabling detailed frequency domain manipulation of tonal components. This selective processing methodology may be applied across a range of audio processing applications, from creative audio effects to audio restoration and enhancement tasks.

The processing of the transient and sinusoidal components can be used to perform various acoustic editing tasks, such as to create modified audio files for playback to a user (e.g., via a speaker, headphones, or other audio output) or the like. Different types of audio editing may use the processed audio files in various manners.

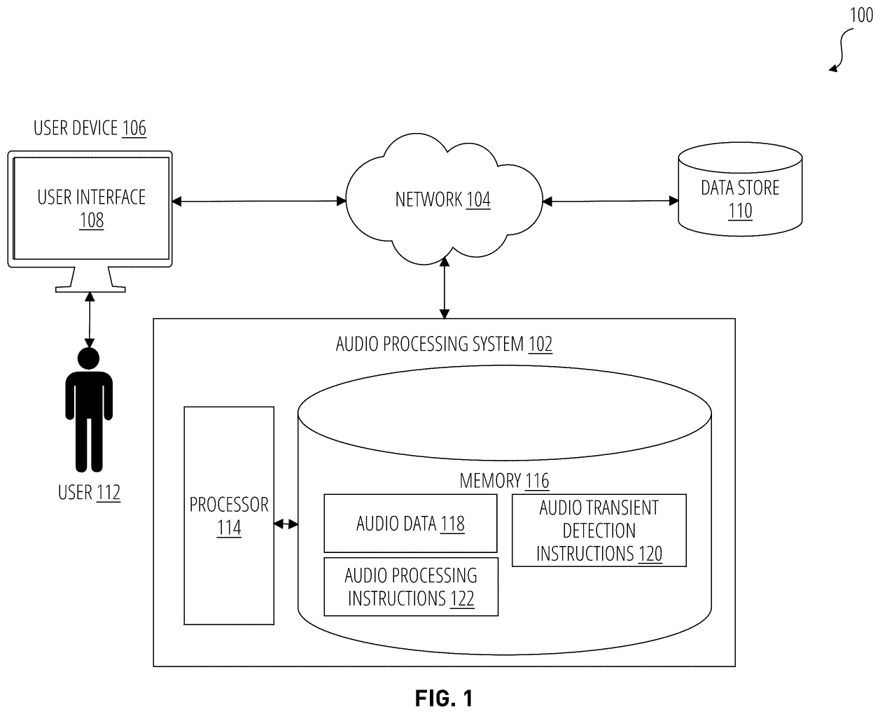

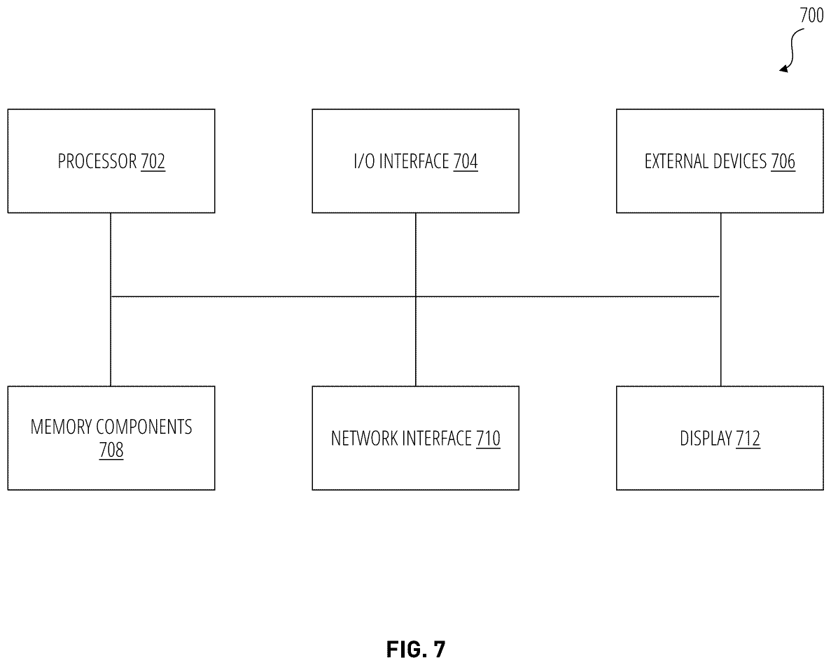

Turning now to the figures, FIG. 1 illustrates an example system 100. The system 100 may be configured to provide a comprehensive framework for audio transient detection and processing operations. The system 100 includes an audio processing system 102 that serves as the central processing component for analyzing and manipulating audio signals in the frequency domain. The system 100 may include a user device 106 and a data store 110 in communication with the audio processing system 102 either directly or via the network 104. In some examples, the audio processing system 102 may be implemented by a device or computing system (e.g., the computing system 700 described with respect to FIG. 7). In some examples, the audio processing system 102 and user device 106 may be incorporated into a single and/or combined device rather than as separate systems. For example, the audio processing system 102 may be hosted on the user device 106 as an application. In such examples, the audio processing system 102 may communicate with the user device 106 directly instead of via the network 104. In some examples, the audio processing system 102 may be in communication with one or more user devices 106 and/or data stores 110.

The user device 106 provides an interface for user interaction with the audio processing capabilities. The user device 106 The user device 106 may include computing devices such as desktop computers, laptops, tablets, mobile devices, handheld devices, robotic systems, controllers, virtual devices, and/or the like that may enable a user 112 to initiate audio processing operations, configure parameters, and monitor processing results. For example, the user 112 may engage with the audio processing system 102 via a user interface 108 presented at the user device 106 to detect audio transients in an audio file and apply a filter to the audio transients. The user interface 108 may provide real-time feedback to the user 112 regarding processing status, detected transient locations, and processing parameters. In some cases, the user interface 108 allows the user 112 to adjust detection thresholds, select processing algorithms, and configure output parameters for different audio processing applications. The user device 106 and network 104 are discussed in further detail with respect to FIG. 7.

In some examples, the user device 106 may include audio output components, such as speakers, headphones, headsets, and/or the like. In some examples, the audio processing system 102 may configure the user device 106 to output audio processed by the audio processing system 102. For example, after editing an audio file via the audio processing system 102, the user 112 may interact with the user device 106 to play back the edited audio file via a speaker of the user device 106.

In some embodiments, the audio processing system 102 may communicate with a data store 110 (e.g., via the network 104). The data store 110 may be configured to provide storage capabilities for various types of information related to audio processing operations. For example, the data store 110 may store audio files, processed audio, and configuration data used by the audio processing system 102. The data store 110 may include memory storage (e.g., database systems, file storage systems, or cloud-based storage solutions) configured maintain persistent data for system operations. The data store 110 may be implemented as one storage device (e.g., a physical device) or distributed across various storage devices. In some embodiments, the data store 110 may be in communication with additional systems not shown in FIG. 1.

In some embodiments, the audio processing system 102 includes a processor 114 and memory 116. The processor 114 may provide computational capabilities for executing various operations related to the audio processing system 102. The processor 114 may include one or more central processing units, microprocessors, and/or other computational elements that perform audio processing tasks. The memory 116 may be communicatively coupled to the processor 114 and configured to provide storage capabilities for data, instructions, and other information used by the audio processing system 102. The memory 116 may be communicatively coupled to the processor 114 and configured to provide storage capabilities for data, instructions, and other information used during audio processing operations. The memory 116 may include and/or access various types of data or instructions used by the audio processing system 102. Such data and instructions may include audio data 118, audio transient detection instructions 120, and audio processing instructions 122 in various examples. Such data and instructions may be stored on and/or executed by a computing system 700 as described with respect to FIG. 7. The memory 116 may include various types of storage media such as random access memory, read-only memory, flash memory, or other volatile or non-volatile storage technologies that enable data retention and retrieval during system operation. The processor 114 and memory 116 are described in further detail with respect to FIG. 7. In some embodiments, the audio processing system 102 may include and/or communicate with additional components and/or systems not shown in FIG. 1.

In some embodiments, the audio processing system 102 includes audio data 118 stored e.g., in memory 116. The audio data 118 may include input audio signals that undergo transient detection and processing. For example, the audio data 118 may include a song selected or uploaded by the user 112 (e.g., via the user interface 108) for audio editing. The audio processing system 102 may receive the audio data 118 from the user device 106 and/or data store 110. For example, the user 112 may create and/or upload an audio file at the user device 106. The audio processing system 102 may communicate with the user device 106 (e.g., via the network 104) to retrieve the audio file. In another example, the data store 110 may be a database configured to store audio files. The audio processing system 102 may communicate with the data store 110 (e.g., via the network 104) to retrieve the audio files.

In some embodiments, the audio processing system 102 includes audio transient detection instructions 120 and audio processing instructions 122 stored e.g., in memory 116. The audio transient detection instructions 120 may include instructions that, when executed by the processor 114, cause the audio processing system 102 to identify audio transient components of the audio data 118. The audio processing instructions 122 may include instructions that, when executed by the processor 114, cause the audio processing system 102 to manipulate detected transients and performing various audio processing operations such as pitch shifting, time stretching, and noise reduction on the audio data 118.

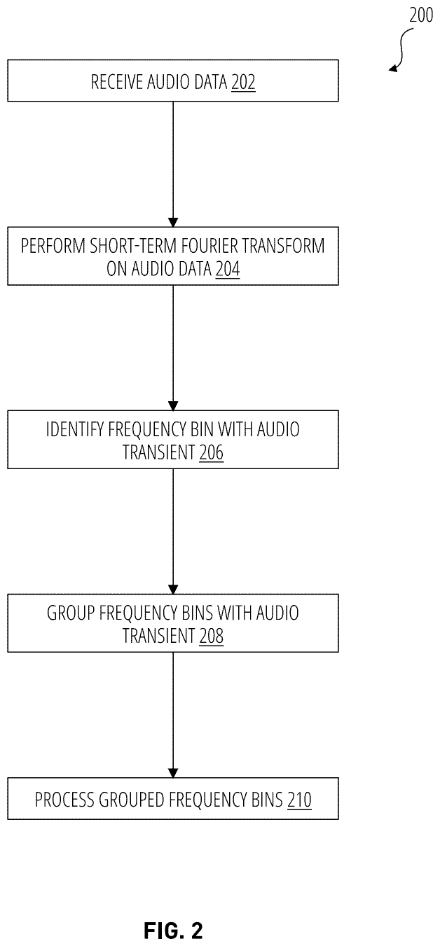

The audio processing system 102 may execute the audio transient detection instructions 120 to analyze phase relationships and instantaneous frequency characteristics across frequency bins within Short-Term Fourier Transform representations. The detection process involves calculating instantaneous frequencies for individual frequency bins and comparing these frequencies to identify asynchronous behavior that indicates transient content. The processor 114 may also execute magnitude-based detection algorithms that complement the phase-based analysis by identifying sudden changes in energy levels across audio frames. The combination of phase-based and magnitude-based detection techniques provides robust identification of transient components within complex audio signals. Once transients are detected, the processor 114 may execute the audio processing instructions 122 to cluster related transient components and apply targeted processing operations that preserve the acoustic characteristics of transient events. The audio transient detection instructions 120 and audio processing instructions 122 are discussed in further detail with reference to method 200 of FIG. 2.

While the data and instructions, such as the audio data 118, audio transient detection instructions 120, and audio processing instructions 122 are shown in FIG. 1 as being stored in the memory 116, in some examples, the data and instructions may be stored at other memory resources of the audio processing system 102 and/or at locations remote from the audio processing system 102, such as various databases or data stores (e.g., data store 110). In such examples, the memory 116 may include instructions for accessing such data and instructions from remote locations, including, for example, the locations of the data and/or specific queries used to retrieve data for use by the audio processing system 102.

The audio processing system 102 may be implemented by or at a computing device or combinations of computing resources in various embodiments. In various examples, the audio processing system 102 may be implemented by one or more servers, cloud computing resources, and/or other computing devices. The audio processing system 102 may, for example, be incorporated as a module within a mobile application, software application, or a website presented through a web browser (e.g., at a laptop or desktop computer), and the like.

The components of FIG. 1 are exemplary only. In various examples, the audio processing system 102 may communicate with and/or include additional components and/or functionality not shown in FIG. 1. For example, the audio processing system 102 may communicate with an audio mixing system configured to mix and/or modify audio.

FIG. 2 illustrates an example method 200 for detecting audio transients and processing audio data through frequency domain analysis. The method 200 enables identification and targeted processing of transient components within audio signals while maintaining the integrity of both transient and non-transient spectral content. In some examples, the audio processing system 102 may perform method 200 by executing the audio transient detection instructions 120 and/or audio processing instructions 122 (e.g., via the processor 114). Although the example method 200 depicts a particular sequence of operations, the sequence may be altered without departing from the scope of the present disclosure. For example, some of the operations depicted may be performed in parallel or in a different sequence. In other examples, different components of an example device or system that implements the method 200 may perform functions at substantially the same time or in a specific sequence. The method 200 may make use of any embodiment for detecting transients and processing audio data 118 with the audio processing system 102.

At operation 202, the audio processing system 102 receives audio data 118 for processing. The audio data 118 may represent the input data that undergoes subsequent frequency domain analysis and transient detection operations. For example, the user 112 may interact with the user interface 108 to select and/or upload an audio file that the user 112 wishes to edit. The audio processing system 102 may communicate with the user device 106 and/or data store 110 (e.g., directly or via the network 104) to retrieve the audio file.

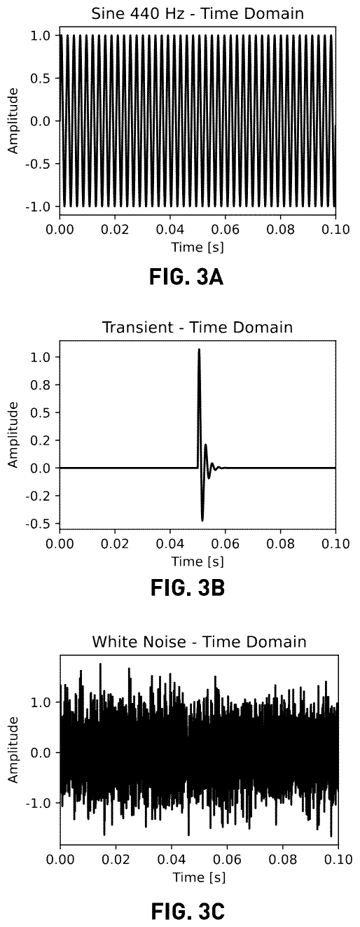

FIG. 3A, FIG. 3B, and FIG. 3C, portray example time domain representations of different types of audio signals that may be represented in the audio data 118. Different types of audio signals exhibit distinct characteristics in their time-domain representations that influence their behavior during frequency-domain processing operations. These signal types include sinusoidal signals, transient signals, and noise signals, each presenting unique temporal patterns that affect spectral analysis and processing outcomes. The audio processing system 102 may process the time-domain characteristics of these signal types to enable frequency-domain processing techniques that can distinguish between different acoustic components and apply appropriate processing strategies to each signal type.

FIG. 3A illustrates an example sinusoidal signal at 440 Hz rendered at a sample rate of 44.1 kHz, demonstrating the regular, periodic waveform characteristic of tonal audio content. The sinusoidal signal exhibits a continuous oscillation with consistent amplitude and frequency over the displayed time period. The waveform may exhibit a predictable rise and fall pattern, where the signal completes regular cycles at the specified frequency. This periodic behavior results in well-defined spectral characteristics when transformed to the frequency domain, with energy concentrated at the fundamental frequency and related harmonic components. The temporal stability of sinusoidal signals makes them well-suited for frequency domain analysis techniques that assume periodic or quasi-periodic signal behavior.

FIG. 3B illustrates an example an audio transient signal rendered at a sample rate of 44.1 kHz, showing the sharp, impulsive characteristics that distinguish transient events from other audio signal types. The transient signal exhibits a rapid onset with high amplitude followed by a quick decay, creating a brief but energetic acoustic event. The waveform demonstrates the non-periodic nature of transient signals, where the energy is concentrated within a short time interval rather than distributed across multiple cycles. This temporal concentration of energy results in broadband spectral content when analyzed in the frequency domain, with energy spread across multiple frequency bins rather than concentrated at specific frequencies. The brief duration and high energy density of transient signals present challenges for frequency domain processing techniques that are optimized for periodic signal content.

As portrayed FIG. 3B, in some examples, the transient signal shows minimal energy before and after the main impulse event, indicating the localized nature of transient acoustic phenomena. The sharp attack and rapid decay characteristics may be typical of percussive sounds, plucked string instruments, and other acoustic events that involve sudden energy release. The asymmetric envelope of the transient signal, with its rapid rise time and variable decay characteristics, contributes to the complex spectral behavior observed when such signals undergo frequency domain transformation. The time-localized nature of transient signals makes them particularly sensitive to the temporal resolution and windowing characteristics of Short-Term Fourier Transform analysis, where the choice of frame size and overlap parameters can significantly affect the accuracy of transient representation in the frequency domain.

FIG. 3C illustrates an example white noise signal rendered at a sample rate of 44.1 KHz, exhibiting the random, non-periodic fluctuations characteristic of noise signals across the audio spectrum. The white noise signal demonstrates continuous variation in amplitude with no discernible pattern or periodicity, creating a stochastic waveform that contains energy distributed across all frequencies within the analysis bandwidth. The random nature of the noise signal results in spectral content that varies continuously across frequency bins when analyzed in the frequency domain, without the concentrated energy peaks characteristic of sinusoidal signals or the broadband impulse response typical of transient signals. The statistical properties of noise signals make them fundamentally different from both sinusoidal and transient signals in terms of their spectral behavior and processing requirements.

The amplitude variations in the white noise signal shown in FIG. 3C follow a random distribution that produces a relatively flat spectral response when averaged over time, though individual analysis frames may show significant variation in spectral content. The continuous nature of noise signals means that their spectral characteristics change from frame to frame in frequency domain analysis, creating challenges for processing techniques that assume stable spectral features. The random phase relationships within noise signals result in incoherent spectral components that do not exhibit the synchronized behavior observed in sinusoidal signals or the coherent broadband response characteristic of transient signals. These distinct spectral behaviors necessitate different processing approaches for noise signals compared to sinusoidal and transient components within complex audio signals.

The three signal types illustrated in FIG. 3A, FIG. 3B, and FIG. 3C represent three categories of audio content that may be encountered in real-world audio processing applications. Sinusoidal signals may provide the tonal foundation for musical content and speech formants, while transient signals may contribute percussive characteristics that define the onset and rhythmic elements of audio signals. Noise signals may represent unwanted interference, ambient acoustic environments, or intentional noise-based audio content such as percussion instruments with complex spectral characteristics. The ability to distinguish between these signal types in frequency domain analysis enables targeted processing approaches that can preserve the acoustic integrity of each signal type while applying appropriate modifications based on the specific characteristics and processing requirements of sinusoidal, transient, and noise components.

At operation 204, the audio processing system 102 performs a Short-Term Fourier Transform (STFT) on the audio data 118. The audio processing system 102 may generate a frequency-domain representation of the audio data 118 that enables detailed spectral analysis and transient detection via the frequency domain. In some examples, the STFT may apply Fast Fourier-Transform (FFT) to audio frames of the audio data 118. The frequency-domain representation includes one or more audio frames defining one or more time ranges in the audio data, where each audio frame captures spectral content within a specific temporal window. The frequency domain representation further includes one or more frequency bins in each of the audio frames, where the frequency bins define frequency ranges of the audio data within each audio frame.

The STFT operation provides the foundation for frequency domain analysis of audio signals through systematic decomposition of time-domain waveforms into overlapping spectral frames. The audio processing system 102 may use typical FFT frame sizes of 1024, 2048, and 4096 samples, with powers of 2 selected for computational efficiency in the STFT calculations. The power-of-2 constraint enables the use of efficient STFT algorithms that reduce computational complexity compared to arbitrary frame sizes, making real-time audio processing applications more feasible. Frame size selection affects both temporal and frequency resolution in the STFT analysis, where larger frame sizes provide better frequency resolution at the expense of temporal resolution, while smaller frame sizes offer improved temporal resolution with reduced frequency resolution. The choice of frame size may be adjusted based on the characteristics of the audio content being processed, with smaller frames preferred for transient-rich signals and larger frames suitable for tonal content with stable spectral characteristics.

The audio processing system 102 may use typical sampling rates like 44.1 kHz with frame sizes adjusted proportionally for different sampling rates to maintain consistent time representation across various audio formats. For example, when the sampling rate increases to 96 kHz, the frame size may be scaled proportionally to maintain the same temporal duration for each analysis frame, ensuring consistent temporal resolution regardless of the sampling rate used for audio capture or playback. This proportional scaling approach enables the transient detection algorithms to operate effectively across different audio formats without requiring recalibration of detection parameters or threshold values. In some cases, the frame size scaling may be combined with adjustments to overlap factors and zero padding parameters to optimize the STFT implementation for specific sampling rate and audio content combinations.

The audio processing system 102 may split an audio signal into overlapping frames where the overlap factor o is defined as the inverse of the ratio r that two frames overlap, expressed mathematically as o=1/(1−r). An overlap factor of four corresponds to 75% overlap between adjacent frames, meaning that three-quarters of each frame shares temporal content with neighboring frames. This overlapping structure enables smooth temporal transitions in the frequency domain representation while providing sufficient temporal resolution for transient detection operations. The overlap factor selection affects the temporal granularity of the analysis and influences the accuracy of instantaneous frequency calculations used in transient detection algorithms.

The audio processing system 102 may apply zero padding to interpolate in the frequency domain, enhancing the spectral resolution of the transformed signal representation. A zero padding factor of two extends the frame to twice the original size by adding zeros to the left and right edges of the temporal frame before transformation. This zero padding process increases the number of frequency bins in the resulting spectrum without adding actual signal content, effectively providing interpolation between the original frequency bin locations. The zero padding operation enables more precise frequency analysis and improves the accuracy of peak detection algorithms used in transient identification processes. In some cases, the zero padding factor may be adjusted based on the specific requirements of the audio processing application and the desired balance between computational efficiency and spectral resolution.

Before performing the frequency domain transformation, the audio processing system 102 may rotate the frame around the midpoint to center the phase information of the Discrete Fourier Transform at zero. This frame rotation operation aligns the temporal center of the analysis window with the zero phase reference, providing a consistent phase baseline for subsequent instantaneous frequency calculations. The centering process eliminates phase offsets that would otherwise complicate the interpretation of phase relationships across frequency bins during transient detection operations. The rotation operation may be implemented through circular shifting of the temporal samples within each frame, ensuring that the phase characteristics of the transformed signal reflect the true temporal relationships within the audio content rather than artifacts introduced by the analysis window positioning.

Following the transformation to the frequency domain, the audio processing system 102 may convert complex valued frequency domain information from cartesian coordinates to polar coordinates to work with magnitudes and phases instead of real and imaginary parts. The cartesian representation provides real and imaginary components for each frequency bin, while the polar representation separates the spectral information into magnitude and phase components that are more directly interpretable for audio analysis purposes. The magnitude component represents the energy content at each frequency bin, while the phase component contains timing and frequency deviation information used in instantaneous frequency calculations. This coordinate conversion enables the audio processing system 102 to analyze spectral peaks, calculate instantaneous frequencies, and detect phase synchronization patterns that distinguish sinusoidal components from transient components within the frequency domain representation.

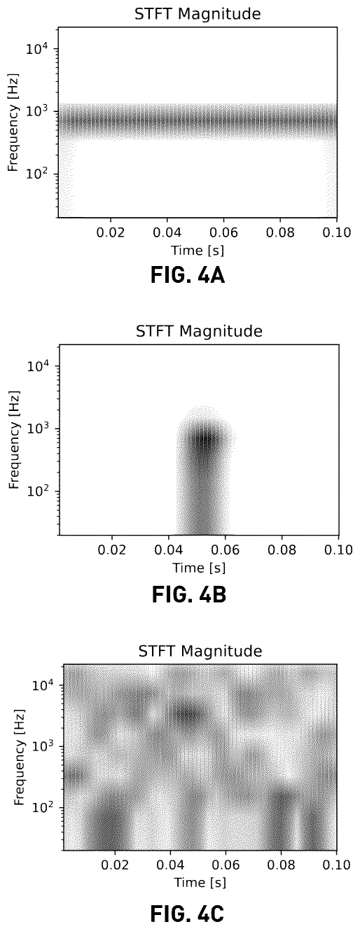

FIG. 4A, FIG. 4B, and FIG. 4C portray example STFT magnitude representations of the example audio signals portrayed in FIG. 3A, FIG. 3B, and FIG. 3C, respectively. FIG. 4A, FIG. 4B, and FIG. 4C demonstrate the spectral characteristics of different audio signal types processed through STFT.

FIG. 4A portrays the STFT magnitude of the example sinusoidal signal of FIG. 3A calculated with a frame size of 1024 samples at 8× overlap using a Hann window, showing the concentrated spectral energy characteristic of tonal content. The consistent horizontal banding pattern across the time domain reflects the stable frequency content of the sinusoidal signal, where energy remains concentrated at the fundamental frequency throughout the analysis period. The horizontal bands in FIG. 4A indicate that the sinusoidal signal maintains its frequency content consistently over time, with the magnitude response showing concentration around the 440 Hz frequency region.

FIG. 4B portrays the STFT magnitude of the example audio transient of FIG. 3B calculated with the same parameters, revealing the localized temporal and broadband spectral characteristics of transient events. The concentrated magnitude response between approximately 0.04 and 0.06 seconds demonstrates the brief temporal duration of transient signals, while the vertical spread across frequency bins indicates the broadband spectral content typical of impulsive acoustic events. The magnitude pattern in FIG. 4B shows energy distributed across a wide frequency range during the transient event, contrasting with the frequency-localized pattern observed in the sinusoidal signal of FIG. 4A. The temporal localization of the transient energy creates a distinct pattern in the time-frequency representation, where high magnitude values appear across multiple frequency bins but only during the brief duration of the transient event.

FIG. 4C portrays the STFT magnitude of the example white noise of FIG. 3C calculated with the same parameters, showing the distributed spectral energy characteristic of stochastic signals. The complex pattern of varying magnitudes distributed across both frequency and time domains reflects the nature of noise signals, where spectral content changes continuously across analysis frames without the stable patterns observed in sinusoidal signals or the localized energy concentration characteristic of transient signals. The magnitude representation in FIG. 4C displays a more chaotic and continuously varying pattern compared to both the sinusoidal and transient signals, with energy distributed across the entire time-frequency plane in an irregular manner. The random distribution of magnitude values across both temporal and spectral dimensions creates a textured appearance that distinguishes noise signals from the more structured patterns exhibited by sinusoidal and transient components.

These magnitude representations may be used by the audio processing system 102 to distinguish between different signal types during transient detection operations, where the temporal and spectral distribution patterns serve as indicators of the underlying acoustic content. The audio processing system 102 may analyze these magnitude patterns to identify regions of interest for further phase-based analysis, using the temporal localization characteristics observed in FIG. 4B to focus transient detection algorithms on time intervals that exhibit broadband energy distribution. The stable horizontal patterns in FIG. 4A indicate sinusoidal content that may be processed using conventional frequency domain techniques, while the distributed patterns in FIG. 4C suggest noise-like content that requires specialized handling to avoid artifacts during processing operations. The characteristics of these three magnitude representations demonstrate how STFT analysis can reveal the fundamental differences between sinusoidal, transient, and noise signal types in the frequency domain.

However, if the audio processing system 102 considers only magnitudes, the magnitude spectrum of the white noise (FIG. 4C) could be interpreted to include multiple small sinusoids quickly fading in and out, or multiple audio transients at different frequencies. Thus, it is insufficient to consider magnitude alone when detecting audio transients as magnitude analysis may be insufficient to distinguish white noise and audio transients.

At operation 206, the audio processing system 102 identifies frequency bins containing audio transients within the frequency-domain representation generated by the operation 204. The audio processing system 102 may analyze phase relationships and instantaneous frequency characteristics across the frequency bins to distinguish transient components from sinusoidal components within the spectral representation. The audio processing system 102 may calculate instantaneous frequencies for individual frequency bins and compare these frequencies across adjacent bins to identify asynchronous behavior that indicates transient content. In some examples, the audio processing system 102 combines phase-based analysis with magnitude-based detection techniques that examine energy changes across audio frames to provide robust transient identification. The audio processing system 102 may apply threshold criteria to determine whether detected spectral features constitute transient components based on the degree of phase asynchronicity and magnitude variation observed in the frequency bins.

The audio processing system 102 may use linearly spread frequency bins where center frequencies can be calculated based on bandwidth and number of bins within the STFT representation. The linear frequency distribution ensures that adjacent frequency bins are separated by equal frequency intervals, providing uniform spectral resolution across the analysis bandwidth. The center frequency of each bin may be calculated by dividing the total analysis bandwidth by the number of frequency bins and multiplying by the bin index, creating a predictable frequency grid for spectral analysis operations. This linear binning structure enables straightforward calculation of instantaneous frequencies and frequency deviations used in transient detection operations, where the regular spacing between bin centers provides a consistent reference for measuring frequency variations across the spectrum. As described herein, instantaneous frequency represents a frequency deviation of a true frequency from the frequency represented by a bin center. The linear frequency distribution also facilitates efficient implementation of spectral processing operations that require knowledge of the frequency relationships between adjacent bins.

The audio processing system 102 may calculate instantaneous frequency for each frequency bin using a mathematical formula that incorporates phase information, overlap factors, and frequency bin characteristics to determine the true frequency content within each spectral component. The instantaneous frequency calculation employs the formula

$${f}_{i} = d \cdot b + d \cdot o \cdot \frac{mod ( ( p [ x ] - p [ x - 1 ] ) - ( 2 π / o ) + π , 2 π ) - π}{2 π} ,$$

where p represents the phase values, o represents the overlap factor, b represents the current bin index, and d represents the Nyquist limit (half the sample rate) divided by the number of frequency bins. The phase difference term (p[x]−p[x−1]) captures the change in phase between consecutive analysis frames, providing information about frequency deviations from the nominal bin center frequencies. The modulo operation ensures that phase differences remain within the appropriate range for accurate frequency calculations, while the overlap factor compensation accounts for the expected phase advancement due to frame overlap in the Short-Term Fourier Transform implementation.

The instantaneous frequency calculation provides a mechanism for detecting frequency content that deviates from the center frequencies of individual frequency bins within the STFT representation. Each frequency bin has a nominal center frequency determined by its position within the frequency grid, but actual audio content may contain frequency components that fall between these center frequencies. The instantaneous frequency formula enables the audio processing system 102 to measure these frequency deviations by analyzing phase progression across consecutive analysis frames. When audio content contains a sinusoidal component at a frequency that does not align exactly with a bin center frequency, the phase information evolves in a predictable manner that reflects the frequency offset. The audio processing system 102 may use this phase evolution to calculate the true frequency of the spectral component, providing more accurate frequency analysis than would be possible using only the nominal bin frequencies.

The audio processing system 102 may determine a first instantaneous frequency of a first frequency bin by applying the instantaneous frequency formula to phase measurements obtained from consecutive STFT analysis frames. The calculation process involves extracting phase values for the first frequency bin from current and previous analysis frames, computing the phase difference, and applying the overlap factor compensation to account for the expected phase advancement due to frame overlap. The resulting instantaneous frequency value represents the true frequency content within the first frequency bin, which may deviate from the nominal center frequency of the bin depending on the spectral characteristics of the audio content. The audio processing system 102 may perform this calculation for multiple frequency bins within each analysis frame, generating an array of instantaneous frequency values that characterize the spectral content across the frequency range of interest.

The audio processing system 102 may determine a first audio transient by comparing the first instantaneous frequency with one or more instantaneous frequencies of one or more frequency bins to identify asynchronous behavior that indicates transient content. The comparison process involves analyzing the instantaneous frequency values across adjacent or nearby frequency bins to detect patterns of synchronization or asynchronization that characterize different types of audio content. When the first instantaneous frequency and the one or more instantaneous frequencies synchronize to a sinusoidal frequency, the spectral content represents tonal components that exhibit coherent phase relationships across multiple frequency bins. Conversely, when the instantaneous frequencies do not synchronize to a sinusoidal frequency, the asynchronous behavior indicates transient or noise content that does not conform to the sinusoidal model assumed by frequency domain analysis techniques. The audio processing system 102 may quantify the degree of asynchronization using mathematical measures that compare instantaneous frequency values across bins, enabling threshold-based detection of transient components within the frequency domain representation.

The audio processing system 102 may calculate a normalized Energy Difference using a mathematical formula that quantifies changes in spectral energy between consecutive analysis frames within the Short-Term Fourier Transform representation. The Energy Difference calculation employs the formula

$${E}_{diff} [ x ] = \frac{E [ x ] - E [ x - 1 ]}{E [ x - 1 ]} ,$$

E represents the Magnitude Sum Energy for each analysis frame. The Magnitude Sum Energy E may be computed by summing all magnitude values within a frequency domain frame and dividing by the number of magnitude bins, providing a normalized measure of the total spectral energy present in each temporal analysis window. The Energy Difference formula captures the relative change in energy between the current frame E[x] and the previous frame E[x−1], expressed as a normalized ratio that accounts for the baseline energy level in the previous frame. This normalization approach enables consistent detection performance across audio signals with varying overall amplitude levels, where the relative energy change provides a more reliable indicator of transient events than absolute energy measurements.

The Energy Difference calculation provides a mechanism for detecting sudden changes in spectral energy that characterize transient acoustic events within audio signals. When a transient event occurs, the Magnitude Sum Energy may exhibit a rapid increase from the baseline level established in previous analysis frames, resulting in a positive Energy Difference value that exceeds detection thresholds. The audio processing system 102 may implement safeguards to avoid division by zero in the Energy Difference calculation by using a maximum function that selects either a predetermined lower bound or the actual E[x−1] value as the divisor. This approach ensures numerical stability when processing audio signals that contain periods of silence or very low amplitude content, where the previous frame energy E[x−1] approaches zero. The Energy Difference measure may be combined with other detection criteria to provide comprehensive transient identification that accounts for both energy-based and phase-based indicators of transient content within frequency domain representations.

The audio processing system 102 may use a Magnitude Criterion for detecting impulse-like transients based on spectral shape characteristics that distinguish brief impulsive events from other types of audio content within the frequency domain representation. The Magnitude Criterion analyzes Peak Contrast c and Peak magnitude difference m, where these parameters quantify the spectral distribution patterns characteristic of impulse-like transients. Peak Contrast c may be defined as the ratio of a spectral peak's maximum magnitude to its largest minimum magnitude within the surrounding frequency region, providing a measure of how prominently the peak stands out from the local spectral background. Peak magnitude difference m may represent the magnitude ratio between a spectral peak's maximum value and the maximum value of adjacent spectral peaks, indicating the relative prominence of individual peaks within the overall spectral distribution. These magnitude-based measures complement the phase-based transient detection techniques by identifying spectral patterns that occur when very brief acoustic events undergo STFT analysis.

The Magnitude Criterion employs threshold relationships expressed as

$$\frac{1}{{t}_{m}} < c < {t}_{m} and \frac{1}{{t}_{m}} < m < {t}_{m} ,$$

where tₘ represents a psychoacoustically determined threshold parameter that defines the acceptable range for Peak Contrast and Peak magnitude difference values. The threshold relationships establish bounds that identify spectral patterns characteristic of impulse-like transients, where values falling within the specified ranges indicate the presence of brief impulsive events. The symmetric threshold structure around the reciprocal values ensures that both overly flat spectral responses and excessively peaked spectral distributions are excluded from transient classification, focusing detection on the intermediate spectral characteristics that typify genuine impulse-like transients. The audio processing system 102 may adjust the threshold parameter tₘ based on the specific characteristics of the audio content being analyzed, where different threshold values enable detection sensitivity tuning for various types of transient events and acoustic environments.

Short impulses within Short-Term Fourier Transform representations exhibit distinctive magnitude response characteristics that enable their identification through spectral shape analysis techniques. When brief impulsive events undergo STFT analysis, the resulting magnitude spectrum typically displays a relatively flat response across the frequency range, contrasting with the more variable spectral patterns observed in other types of audio content. This flat magnitude response occurs because the brief temporal duration of impulse-like transients result in broadband spectral content that distributes energy across multiple frequency bins without the concentrated peaks characteristic of sinusoidal components. The spectral flatness of impulse responses differs from white noise patterns, where noise signals exhibit volatile magnitude variations in detailed spectral analysis despite producing similar overall spectral distributions when averaged over longer time periods. The distinction between impulse and noise spectral characteristics becomes apparent in short-term analysis windows, where the temporal localization of impulse events creates coherent broadband responses that differ from the random spectral fluctuations associated with noise signals.

The audio processing system 102 may apply an auto-whitening process to remove formant or spectral curvature before measuring Peak Contrast and Peak magnitude difference values within the frequency domain representation. The auto-whitening process addresses spectral distortions that may be introduced by the frequency response characteristics of audio recording equipment, acoustic environments, or the natural formant structure of speech and musical instruments. These spectral colorations can affect the accuracy of Peak Contrast and Peak magnitude difference measurements by introducing systematic variations in the magnitude spectrum that are unrelated to the presence of transient events. The auto-whitening operation may involve estimating the overall spectral envelope of the audio signal and applying inverse filtering to flatten the magnitude response, creating a more uniform spectral baseline for transient detection operations. This preprocessing step enables more accurate measurement of the intrinsic spectral characteristics of transient events by removing extraneous spectral variations that could interfere with the magnitude-based detection criteria.

The auto-whitening process may be implemented through spectral envelope estimation techniques that analyze the magnitude spectrum across multiple analysis frames to identify persistent spectral features that represent formant structure or equipment response characteristics. The audio processing system 102 may compute a smoothed spectral envelope by applying temporal and frequency domain averaging operations to the magnitude spectrum, creating a reference curve that captures the long-term spectral characteristics of the audio signal. The inverse of this spectral envelope may then be applied as a multiplicative correction factor to the magnitude spectrum of each analysis frame, effectively flattening the spectral response and removing systematic spectral variations. The auto-whitening operation preserves the relative magnitude relationships within individual analysis frames while normalizing the overall spectral distribution, enabling more accurate assessment of Peak Contrast and Peak magnitude difference values that reflect the true spectral characteristics of transient events rather than artifacts introduced by spectral coloration effects.

The combination of Energy Difference calculations and Magnitude Criterion analysis provides complementary detection mechanisms that address different aspects of transient identification within frequency domain audio processing applications. The Energy Difference measure captures the temporal dynamics of transient events through analysis of energy changes between consecutive analysis frames, while the Magnitude Criterion focuses on the spectral shape characteristics that distinguish impulse-like transients from other types of audio content. The audio processing system 102 may determine a change in amplitude magnitude in an audio frame by computing the Energy Difference value and comparing the result to a threshold magnitude value that establishes the minimum energy change required for transient classification. When the change in magnitude exceeds the threshold magnitude value, the audio processing system 102 may classify the corresponding spectral content as containing transient components that warrant separate processing treatment. The threshold magnitude value may be adjusted based on the noise floor characteristics of the audio signal and the desired sensitivity level for transient detection operations, enabling adaptation to different audio processing scenarios and content types.

The audio processing system 102 may calculate noisiness values for individual spectral peaks using a mathematical formula that quantifies the degree of instantaneous frequency synchronization within each peak. The noisiness calculation employs the formula n=min (|fᵢ[b]−fᵢ[b+1]|, |fᵢ[b]−fᵢ[b−1]|), where b represents the frequency bin index corresponding to the magnitude maximum within the spectral peak, and fᵢ represents the instantaneous frequency values calculated for adjacent frequency bins. The formula computes the minimum absolute difference between the instantaneous frequency of the peak maximum bin and the instantaneous frequencies of its immediate neighbors, providing a measure of how closely the instantaneous frequencies align across the peak region. When instantaneous frequencies synchronize across adjacent bins within a peak, the noisiness value approaches zero, indicating coherent spectral behavior characteristic of sinusoidal components. Conversely, when instantaneous frequencies exhibit large differences between adjacent bins, the noisiness value increases, indicating asynchronous behavior characteristic of transient or noise-like spectral content.

The minimum function within the noisiness calculation ensures that the synchronization assessment focuses on the most coherent frequency relationship within the immediate vicinity of the peak maximum. By selecting the smaller of the two frequency differences, the formula provides a conservative measure of synchronization that responds quickly to coherent behavior while remaining sensitive to asynchronous patterns. The use of the magnitude maximum bin as the reference point for the calculation ensures that the noisiness assessment focuses on the most prominent spectral component within each peak, where synchronization patterns are most likely to be clearly observable. The audio processing system 102 may compute noisiness values for all identified spectral peaks within each analysis frame, generating an array of noisiness measurements that characterize the synchronization behavior across the entire frequency spectrum.

The noisiness measurement provides a quantitative indicator of whether a spectral peak represents sinusoidal content or transient content based on the instantaneous frequency synchronization patterns observed across adjacent frequency bins. Sinusoidal components typically produce low noisiness values because the underlying periodic waveform creates coherent phase relationships that result in synchronized instantaneous frequencies across the spectral peak region. The coherent phase progression associated with sinusoidal signals causes adjacent frequency bins within the same spectral peak to exhibit similar instantaneous frequency values that converge toward the true frequency of the underlying sinusoidal component. Transient components produce high noisiness values because the broadband, impulsive nature of transient signals creates incoherent phase relationships that result in asynchronous instantaneous frequencies across the spectral peak region. The random or rapidly changing phase characteristics of transient signals cause adjacent frequency bins to exhibit significantly different instantaneous frequency values that do not converge toward a common frequency reference.

The audio processing system 102 may implement a Noisiness Criterion for transient detection that combines the noisiness measurement with energy-based detection parameters to provide robust identification of transient spectral content. The Noisiness Criterion employs the mathematical relationship n·min (|E_{difd}|,1)>tₙ, where n represents the noisiness value calculated for a spectral peak, E_{diff} represents the Energy Difference measurement between consecutive analysis frames, and tₙ represents a psychoacoustically determined frequency dependent threshold parameter. The criterion multiplies the noisiness value by a clipped version of the absolute Energy Difference, where the minimum function limits the Energy Difference contribution to a maximum value of one to prevent overrepresentation of energy-based detection factors. The threshold parameter tₙ establishes the minimum combined noisiness and energy change value that indicates the presence of transient content within a spectral peak.

The frequency dependent nature of the threshold parameter tₙ enables the audio processing system 102 to adapt transient detection sensitivity based on the spectral characteristics and psychoacoustic properties of different frequency regions within the audio spectrum. Human auditory perception exhibits varying sensitivity to transient events across different frequency ranges, with some frequency regions showing greater sensitivity to impulsive sounds while others demonstrate reduced transient detection capabilities. The frequency dependent threshold allows the detection algorithm to account for these perceptual variations by applying different sensitivity levels across the frequency spectrum. Lower frequency regions may employ different threshold values compared to higher frequency regions, reflecting the frequency-dependent characteristics of human transient perception and enabling more perceptually relevant transient detection performance. The audio processing system 102 may implement the frequency dependent threshold through lookup tables, mathematical functions, or adaptive algorithms that adjust threshold values based on the center frequency of each spectral peak.

The combination of noisiness and energy difference measurements within the Noisiness Criterion provides complementary information about transient events that addresses both spectral and temporal characteristics of transient acoustic phenomena. The noisiness component captures the spectral incoherence associated with broadband transient signals, while the energy difference component captures the temporal dynamics associated with sudden energy changes during transient events. The multiplication of these two factors creates a combined detection metric that responds strongly when both spectral asynchronicity and temporal energy changes occur simultaneously, as typically happens during genuine transient events. The clipping of the Energy Difference term prevents situations where extremely large energy changes dominate the detection criterion, ensuring that both spectral and temporal factors contribute meaningfully to the transient detection decision. The audio processing system 102 may evaluate the Noisiness Criterion for each spectral peak within every analysis frame, generating transient detection decisions that identify which peaks contain transient content and which peaks represent sinusoidal or other non-transient spectral components.

The audio processing system 102 may implement adjustable threshold systems that enable fine-tuning of transient detection sensitivity based on the characteristics of the audio content and the specific requirements of the processing application. The threshold adjustment capability allows the audio processing system 102 to adapt detection parameters to capture different ranges of transient events, from subtle acoustic changes to prominent impulsive sounds. High threshold values may be configured to capture only intense transients that exhibit strong spectral asynchronicity and substantial energy changes, focusing detection on the most prominent transient events within the audio signal. These high threshold settings may be appropriate for applications where processing resources are limited or where only the most significant transient events require separate treatment from sinusoidal components. The selective detection approach enabled by high thresholds ensures that processing operations focus on transient events that have the greatest impact on perceived audio quality and acoustic character.

Low threshold values may be configured to capture more transients including noise-like spectral content that exhibits moderate levels of asynchronicity or energy variation. The increased sensitivity provided by low threshold settings enables detection of subtle transient events that might otherwise be classified as sinusoidal content, expanding the range of spectral components that receive specialized transient processing treatment. Low threshold configurations may be appropriate for applications requiring comprehensive transient analysis or where preservation of subtle acoustic details takes precedence over computational efficiency considerations. The expanded detection capability provided by low thresholds enables more thorough separation of transient and sinusoidal components, potentially improving the quality of frequency domain processing operations that benefit from detailed spectral classification. The trade-off associated with low threshold settings involves increased computational requirements and the potential inclusion of noise-like content that may not represent genuine transient acoustic events.

The threshold adjustment mechanism may operate on multiple detection parameters simultaneously, enabling coordinated tuning of both noisiness-based and magnitude-based detection criteria. The audio processing system 102 may adjust the frequency dependent threshold parameter tₙ used in the Noisiness Criterion to modify the sensitivity of phase-based transient detection operations. Higher values of tₙ reduce detection sensitivity by requiring greater degrees of instantaneous frequency asynchronicity before spectral content is classified as transient, while lower values of tₙ increase detection sensitivity by accepting smaller deviations from synchronized behavior as indicators of transient content. The audio processing system 102 may also adjust the threshold magnitude value used in Energy Difference calculations to modify the sensitivity of energy-based transient detection operations. The coordinated adjustment of multiple threshold parameters enables balanced tuning of the detection system that maintains consistent performance characteristics across different detection mechanisms while adapting to the specific requirements of various audio processing scenarios.

The audio processing system 102 may implement adaptive threshold adjustment algorithms that automatically modify detection parameters based on the statistical characteristics of the audio signal being processed. Adaptive threshold systems may analyze the distribution of noisiness values, energy difference measurements, and other detection metrics across multiple analysis frames to establish appropriate threshold levels for the current audio content. The adaptive approach enables automatic optimization of detection sensitivity without requiring manual parameter adjustment, improving the robustness of transient detection operations across diverse audio content types. The audio processing system 102 may compute statistical measures such as mean values, standard deviations, or percentile rankings of detection metrics to inform threshold adjustment decisions. In some cases, the adaptive threshold system may implement feedback mechanisms that monitor the performance of transient detection operations and adjust threshold parameters to maintain consistent detection quality across varying audio signal characteristics.

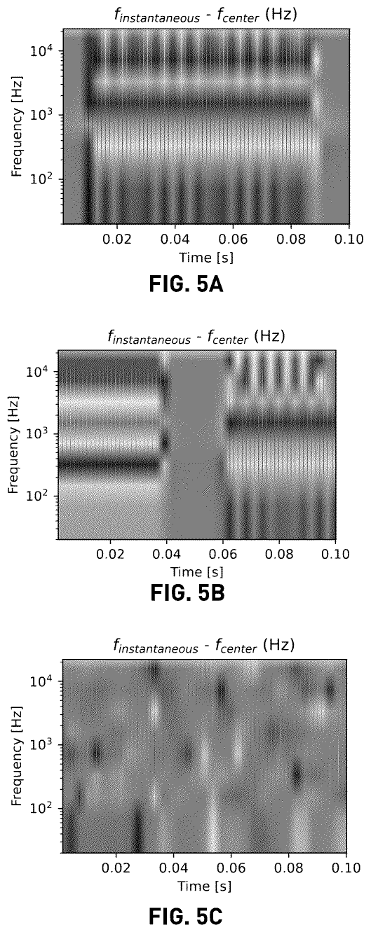

FIG. 5A, FIG. 5B, and FIG. 5C portrays example instantaneous frequency analysis of the example audio signals portrayed in FIG. 3A, FIG. 3B, and FIG. 3C, respectively. The instantaneous frequency analysis reveals patterns that distinguish between different types of audio signals based on their spectral behavior across frequency bins.

FIG. 5A portrays the difference between measured instantaneous frequencies and bin centers for the example sinusoidal signal portrayed in FIG. 3A, demonstrating the synchronized frequency behavior characteristic of tonal content. The sinusoidal signal exhibits instantaneous frequencies that synchronize around the magnitude peak, creating a coherent pattern where adjacent frequency bins show similar instantaneous frequency values that converge toward the true frequency of the sinusoidal component. The spectrogram in FIG. 5A shows a continuous pattern of frequency content across time from approximately 0.02 to 0.10 seconds, with frequency components ranging from about 100 Hz to 10,000 Hz, where the synchronized behavior creates coherent regions of similar instantaneous frequency values around the spectral peaks.

FIG. 5B portrays the difference between measured instantaneous frequencies and bin centers for the example audio transient portrayed in FIG. 3B, revealing the asynchronous behavior that distinguishes transient content from sinusoidal components within the frequency domain representation. The audio transient shows no synchronization of instantaneous frequencies at and around the magnitude peaks, creating a scattered pattern where adjacent frequency bins exhibit significantly different instantaneous frequency values. The spectrogram in FIG. 5B displays a distinct gap in the frequency content around 0.04-0.06 seconds, with strong frequency components before and after this gap, indicating the temporal localization of the transient event. The asynchronous behavior occurs because transient signals contain broadband spectral content that does not conform to the sinusoidal model assumed by the STFT analysis, resulting in instantaneous frequency measurements that vary randomly across adjacent frequency bins rather than converging toward a common frequency value.

FIG. 5C portrays the difference between measured instantaneous frequencies and bin centers for the example white noise portrayed in FIG. 3C, showing the random distribution of frequency values that reflects the stochastic nature of noise signals. The white noise exhibits no synchronization of instantaneous frequencies at and around magnitude peaks, similar to the transient signal but with a more uniformly distributed pattern across both time and frequency dimensions. The spectrogram in FIG. 5C shows a more scattered and random distribution of frequency components across both time and frequency ranges, with less distinct patterns compared to the other two spectrograms. The scattered instantaneous frequency values reflect the random phase relationships within noise signals, where each frequency bin contains independent spectral content that does not exhibit the coherent phase progression characteristic of sinusoidal components. The audio processing system 102 may distinguish between transient and noise content based on the temporal localization of the asynchronous behavior, where transients show concentrated asynchronous activity within limited time intervals while noise exhibits continuous asynchronous behavior across all analysis frames.

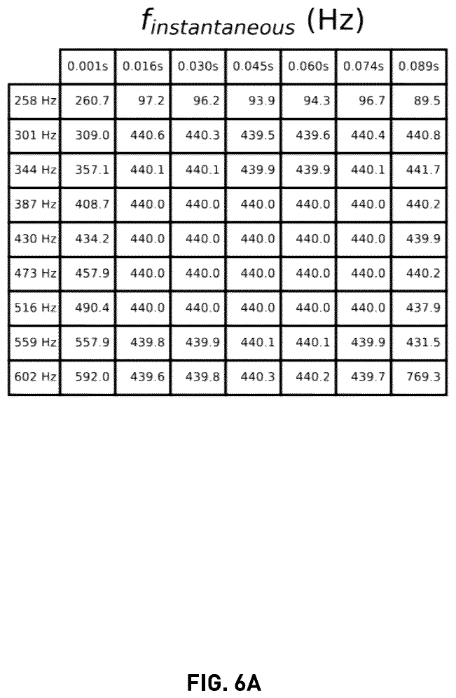

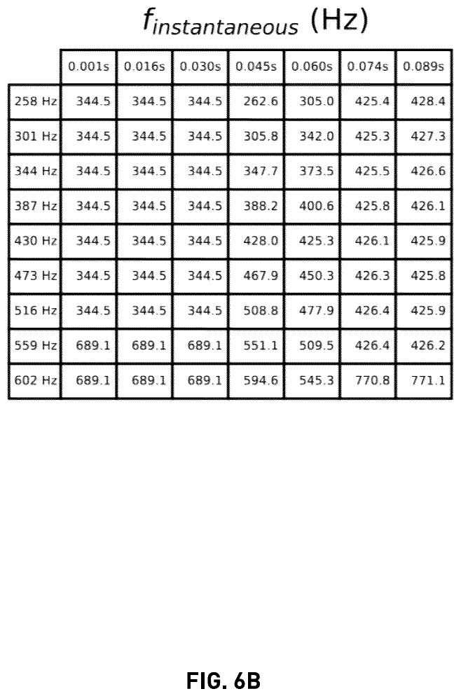

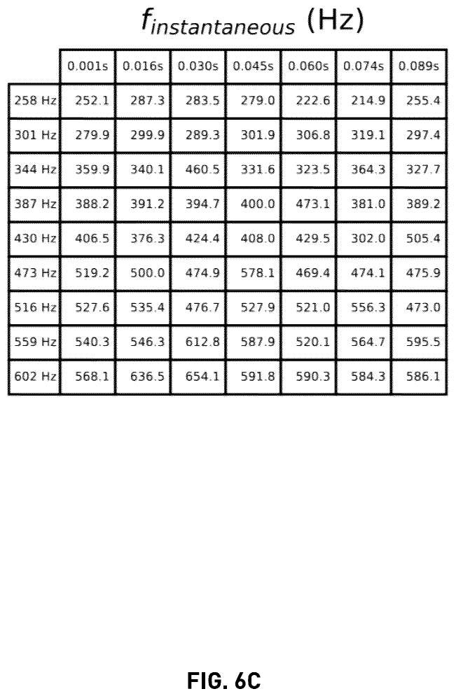

FIG. 6A, FIG. 6B, and FIG. 6C, portrays tabular representations of the instantaneous frequency measurements of FIG. 5A, FIG. 5B, and FIG. 5C, respectively. FIG. 6A, FIG. 6B, and FIG. 6C provide quantitative data that illustrates the synchronization patterns used for transient detection operations.

FIG. 6A portrays instantaneous frequencies of the example sinusoidal signal portrayed in FIG. 3A, showing clear synchronization around the fundamental frequency of 440 Hz with deviations of approximately 0.1 Hz across adjacent frequency bins. The data table displays frequency values arranged in rows corresponding to different Hz measurements ranging from 258 Hz to 602 Hz, with columns showing different time measurements from 0.001 s to 0.089 s. The small frequency deviations demonstrate the measurement precision achievable through instantaneous frequency analysis, where the calculated values converge closely to the true frequency of the sinusoidal component around the 440 Hz region. The consistent frequency values across multiple bins around the spectral peak indicate synchronized behavior that characterizes tonal content, providing a clear signature for sinusoidal detection algorithms.

FIG. 6B demonstrates the instantaneous frequency characteristics of the example audio transient portrayed in FIG. 3B, revealing large deviations from bin to bin compared to the sinusoidal signal shown in FIG. 6A. The transient signal exhibits significant variations in instantaneous frequency values across adjacent bins, reflecting the broadband and impulsive nature of transient acoustic events. The data table in FIG. 6B shows frequency values with much larger variations compared to FIG. 6A, where the instantaneous frequency measurements deviate substantially from the nominal bin center frequencies. The large frequency deviations indicate asynchronous behavior where individual frequency bins contain independent spectral content rather than contributions from a coherent sinusoidal component. Before and after the transient event, the measurements show some degree of synchronization due to the sensitivity of the instantaneous frequency calculation responding to small numerical errors within the STFT analysis, but during the transient event itself, the frequency values exhibit the characteristic asynchronous pattern that enables transient detection.

FIG. 6C portrays instantaneous frequencies of the example white noise portrayed in FIG. 3C, showing large deviations from bin to bin similar to the transient signal but with different temporal characteristics. The noise signal exhibits continuous asynchronous behavior across all measurement intervals, contrasting with the localized asynchronous activity observed in the transient signal. The data table in FIG. 6C displays frequency values that vary randomly across both frequency bins and time intervals, creating a pattern of continuous asynchronous behavior that distinguishes noise from both sinusoidal and transient content. The audio processing system 102 may analyze the temporal distribution of asynchronous behavior to distinguish between transient events and continuous noise content, where transients show concentrated periods of high frequency deviation while noise exhibits sustained asynchronous activity. The combination of magnitude and instantaneous frequency information enables robust detection algorithms that can identify transient components within complex audio signals containing mixtures of sinusoidal, transient, and noise content.

At operation 208, the audio processing system 102 groups frequency bins containing audio transients. The audio processing system 102 may cluster related transient components together based on temporal proximity, spectral characteristics, or other similarity measures that indicate related transient events. The clustering performed by the audio processing system 102 enables coordinated processing of transient components that belong to the same acoustic event, preserving the coherent structure of transient sounds such as percussive attacks or sudden acoustic changes. In some cases, the audio processing system 102 analyzes the spectral distribution of detected transients to determine appropriate grouping strategies that maintain the acoustic integrity of transient events while enabling efficient processing operations.

The audio processing system 102 may implement peak clustering operations that organize frequency domain spectral content into coherent groups based on magnitude distribution patterns across the frequency spectrum. Peak clustering provides a framework for analyzing spectral content in terms of discrete spectral events rather than individual frequency bins, enabling more intuitive processing approaches that align with psychoacoustic perception of audio signals. The clustering process begins with analysis of the magnitude spectrum to identify local minima that serve as natural boundaries between distinct spectral peaks. Local minima represent frequency regions where spectral energy reaches relative minimum values compared to adjacent frequency bins, indicating transitions between different spectral components within the frequency domain representation. The audio processing system 102 may scan across the magnitude spectrum to locate these local minima points, creating a set of frequency boundaries that define the extent of individual spectral peaks.

The spectrum splitting operation divides the frequency domain representation into discrete peaks by establishing boundaries at the identified local minima locations within the magnitude spectrum. Each spectral peak encompasses a contiguous group of frequency bins that share similar spectral characteristics and contribute to the same underlying acoustic event or spectral component. The splitting process creates a segmented representation of the frequency spectrum where each segment corresponds to a distinct spectral peak that may be analyzed and processed independently. The boundaries established by local minima provide natural separation points that preserve the coherent structure of spectral features while enabling targeted analysis of individual peaks. The audio processing system 102 may assign frequency bins to specific peaks based on their position relative to the local minima boundaries, creating a peak membership mapping that associates each frequency bin with its corresponding spectral peak.

The peak clustering approach enables the audio processing system 102 to analyze spectral content in terms of perceptually relevant units that correspond more closely to how acoustic events are perceived by human auditory systems. Individual frequency bins within a spectral peak typically contribute to the same underlying acoustic phenomenon, whether that phenomenon represents a sinusoidal component, a transient event, or a noise-like spectral feature. By grouping related frequency bins into peaks, the audio processing system 102 may apply coherent analysis and processing operations that preserve the internal relationships between spectral components while enabling differentiated treatment of distinct acoustic events. The peak-based representation facilitates detection algorithms that can assess the characteristics of entire spectral features rather than making decisions based on isolated frequency bin measurements that may not capture the full context of the underlying acoustic content.

The clustering process groups detected transients together based on temporal proximity, spectral similarity, or other relationship criteria that indicate related acoustic events within the frequency domain representation. The audio processing system 102 may analyze the temporal distribution of detected transient components to identify groups of transients that occur within close temporal proximity, suggesting that these components may represent different spectral aspects of the same underlying acoustic event. Temporal clustering may involve defining time windows around detected transient events and grouping all transients that fall within the same temporal window into coherent clusters. The temporal window size may be adjusted based on the expected duration of transient acoustic events and the temporal resolution of the Short-Term Fourier Transform analysis. Spectral clustering may involve analyzing the frequency distribution of detected transient components to identify groups of transients that occupy adjacent or related frequency regions within the spectrum.

The clustering algorithm may implement similarity measures that quantify the relationships between different transient components based on their spectral characteristics, temporal characteristics, or combined spectro-temporal features. The audio processing system 102 may calculate similarity scores between pairs of detected transients using metrics that compare instantaneous frequency patterns, magnitude distributions, temporal alignment, or other relevant features. Transient components that exhibit high similarity scores may be grouped together into the same cluster, while transients with low similarity scores may be assigned to separate clusters or processed independently. The similarity threshold used for clustering decisions may be adjusted based on the desired granularity of the clustering operation, where higher similarity thresholds produce fewer, larger clusters while lower similarity thresholds generate more numerous, smaller clusters. The clustering process may employ hierarchical clustering algorithms, k-means clustering approaches, or other machine learning techniques that automatically organize detected transients into coherent groups based on their measured characteristics.

The audio processing system 102 may implement cluster validation mechanisms that assess the quality and coherence of the generated transient clusters before proceeding with processing operations. Cluster validation may involve analyzing the internal consistency of clustered transients to ensure that grouped components share appropriate spectral or temporal characteristics that justify their combined processing treatment. The validation process may compute cluster quality metrics such as intra-cluster similarity measures, inter-cluster separation measures, or silhouette coefficients that quantify the appropriateness of the clustering results. Clusters that fail validation criteria may be subdivided into smaller groups, merged with adjacent clusters, or processed using alternative approaches that account for the heterogeneous nature of their constituent transient components. The cluster validation process helps ensure that the clustering operation produces meaningful groupings that enhance rather than compromise the effectiveness of subsequent processing operations.

At operation 210, the audio processing system 102 processes the grouped frequency bins containing audio transients. The audio processing system 102 may apply targeted processing algorithms to the clustered transient components while treating non-transient spectral content differently to avoid unwanted artifacts or degradation of audio quality. The processing performed by the audio processing system 102 may include frequency modification, amplitude adjustment, filtering operations, or other spectral manipulations that are optimized for transient content characteristics. In some examples, the audio processing system 102 applies different processing parameters to transient clusters compared to sinusoidal components, enabling simultaneous optimization for both transient preservation and frequency domain manipulation capabilities. The audio processing system 102 may generate processed audio output that maintains the percussive character of transient sounds while enabling detailed spectral processing of tonal components within the same audio signal.

In some examples, the audio processing system 102 may process the audio based on user input. For example, the user 112 may interact with the user interface 108 to configure audio editing operations, audio filtering operations, and/or processing parameters. The audio processing system 102 may process the audio data based on the user input.

Processing the cluster of audio transients may include modifying a frequency of each audio transient within the cluster through coordinated spectral manipulation operations that preserve the internal relationships between clustered components. Frequency modification operations may involve shifting the spectral content of all transients within a cluster by the same frequency offset, scaling the frequency content by a common multiplication factor, or applying more complex frequency transformation functions that maintain the relative spectral relationships between cluster members. The coordinated frequency modification approach ensures that transient components that belong to the same acoustic event undergo consistent spectral changes that preserve the coherent structure of the original transient sound. The audio processing system 102 may implement frequency modification through spectral bin reassignment operations that move the spectral content of transient components to new frequency locations within the frequency domain representation while maintaining the magnitude and phase relationships that characterize the transient acoustic event.

Processing the cluster of audio transients may include modifying an amplitude of each audio transient within the cluster through coordinated magnitude adjustment operations that alter the energy content of clustered components while preserving their relative amplitude relationships. Amplitude modification operations may involve scaling the magnitude values of all frequency bins associated with clustered transients by a common multiplication factor, applying dynamic range compression or expansion to the clustered transient content, or implementing more sophisticated amplitude processing functions that account for the spectral distribution characteristics of the transient cluster. The coordinated amplitude modification approach ensures that the relative energy relationships between different spectral components within the transient cluster remain consistent, preserving the acoustic character of the original transient event while enabling overall level adjustments or dynamic processing effects. The audio processing system 102 may implement amplitude modification through direct manipulation of magnitude values in the polar coordinate representation of the frequency domain data, enabling precise control over the energy content of transient components without affecting their phase relationships or spectral distribution patterns.

Processing the cluster of audio transients may include applying a filter to each audio transient within the cluster through coordinated spectral filtering operations that modify the frequency response characteristics of clustered components according to specified filter parameters. Filter application may involve implementing frequency-selective attenuation or amplification across the spectral range occupied by the transient cluster, applying equalization curves that enhance or suppress specific frequency regions within the cluster, or implementing more complex filtering functions such as bandpass, highpass, or lowpass responses that shape the spectral content of the clustered transients. The coordinated filtering approach ensures that all transient components within a cluster receive consistent spectral treatment that maintains the coherent structure of the transient acoustic event while enabling targeted frequency domain modifications. The audio processing system 102 may implement filtering operations through multiplication of the magnitude spectrum by filter response functions, convolution operations in the frequency domain, or other digital signal processing techniques that achieve the desired spectral modification effects while preserving the phase relationships and temporal characteristics of the transient components.

The coordinated processing of clustered transients enables preservation of the acoustic integrity of transient events while allowing targeted modifications that would be difficult to achieve through individual processing of isolated frequency bins. The clustering approach recognizes that transient acoustic events typically distribute their energy across multiple frequency bins within the Short-Term Fourier Transform representation, and that coherent processing of these related spectral components produces better acoustic results than independent processing of individual bins. The audio processing system 102 may apply the same processing parameters to all transient components within a cluster, ensuring that the relative relationships between different spectral aspects of the transient event remain consistent throughout the processing operation. In some cases, the audio processing system 102 may apply processing parameters that vary systematically across the frequency range of a transient cluster, enabling more sophisticated spectral shaping operations while maintaining the coordinated treatment of clustered components. The cluster-based processing approach enables complex audio effects and modifications that preserve the percussive character and acoustic impact of transient sounds while enabling creative or corrective processing operations that enhance the overall quality of the processed audio signal.

Pitch shifting applications may utilize the transient detection and clustering capabilities to modify the pitch of audio signals while correctly placing transient information within the processed output. Traditional pitch shifting algorithms often introduce artifacts when processing transient-rich audio content because uniform frequency domain scaling operations distort the temporal and spectral characteristics of percussive sounds and other impulsive acoustic events. The disclosed approach addresses these limitations by identifying transient components within the frequency domain representation and applying specialized processing techniques that preserve the acoustic integrity of transient events during pitch modification operations. The audio processing system 102 may apply different pitch scaling factors to transient clusters compared to sinusoidal components, enabling independent optimization of pitch shifting parameters for different types of spectral content. The separate treatment of transient and sinusoidal components allows pitch shifting operations to maintain the percussive character and attack characteristics of transient sounds while achieving smooth pitch modifications for tonal components within the same audio signal.

The pitch shifting implementation may involve frequency domain manipulation techniques that relocate spectral content to new frequency positions while preserving the internal relationships between clustered transient components. The audio processing system 102 may calculate new frequency bin assignments for transient clusters based on the desired pitch shift ratio, ensuring that the relative spectral distribution of transient energy remains consistent with the original acoustic event. The phase relationships within transient clusters may be preserved during the pitch shifting operation to maintain the temporal coherence and acoustic impact of percussive sounds. In some cases, the audio processing system 102 may apply interpolation techniques to generate spectral content at intermediate frequency locations when the pitch shift ratio results in non-integer frequency bin mappings. The coordinated processing of transient clusters during pitch shifting operations enables preservation of the rhythmic and percussive elements that contribute to the musical character of audio signals while achieving the desired pitch modifications for melodic and harmonic content.

Time stretching applications may combine pitch shifting operations with resampling techniques to achieve temporal duration changes without altering the perceived pitch of the audio signal. The time stretching process involves applying pitch modifications to compensate for the temporal scaling effects introduced by sample rate conversion operations, resulting in audio output that maintains the original pitch relationships while exhibiting modified temporal characteristics. The transient detection and clustering capabilities enhance time stretching performance by enabling separate treatment of transient and sinusoidal components during both the pitch shifting and resampling stages of the process. The audio processing system 102 may apply different temporal scaling parameters to transient clusters compared to sinusoidal components, accounting for the different temporal characteristics and perceptual requirements of these distinct signal types. The preservation of transient timing relationships during time stretching operations maintains the rhythmic integrity and percussive impact of the original audio signal while achieving the desired temporal modifications.

The time stretching implementation may involve analysis of the temporal distribution of transient events to determine appropriate scaling strategies that preserve the musical timing and rhythmic structure of the audio content. The audio processing system 102 may identify beat locations, rhythmic patterns, or other temporal landmarks within the audio signal based on the distribution of detected transient events, using this information to guide the time stretching process. In some cases, the audio processing system 102 may apply non-uniform temporal scaling that preserves the timing of transient events while allowing more flexible temporal modification of sustained tonal components between transient occurrences. The adaptive temporal scaling approach enables time stretching operations that maintain the musical coherence and rhythmic feel of the original audio signal while achieving significant temporal duration changes that would introduce noticeable artifacts using conventional time stretching algorithms.

Reverb processing applications may utilize adjustable threshold parameters within the transient detection system to identify and manipulate reverberation components within audio signals. Reverberation exhibits spectral characteristics that fall between the synchronized behavior of sinusoidal components and the highly asynchronous behavior of transient components, creating intermediate patterns in instantaneous frequency analysis that may be detected through appropriate threshold adjustment. The audio processing system 102 may modify the frequency dependent threshold parameter tₙ and other detection criteria to capture reverberant spectral content that exhibits moderate levels of instantaneous frequency asynchronicity. The detection of reverberant components enables targeted processing operations that may enhance, reduce, or remove reverberation effects from audio signals while preserving the direct sound components and transient events that contribute to the primary acoustic content.

The reverb detection process may involve analysis of the temporal decay characteristics and spectral distribution patterns associated with reverberant energy within the frequency domain representation. Reverberation typically exhibits gradual energy decay over time with spectral content that becomes increasingly diffuse and asynchronous as the reverberant energy evolves. The audio processing system 102 may track these temporal and spectral evolution patterns to distinguish reverberant components from direct sound components within the same frequency regions. The threshold adjustment mechanism enables fine-tuning of the detection sensitivity to capture different types of reverberant environments, from subtle room acoustics to prominent artificial reverberation effects. The separate identification and processing of reverberant components enables audio restoration applications that remove unwanted reverberation from recordings while preserving the natural acoustic characteristics of the direct sound sources. Declicking applications may focus the transient detection capabilities on identifying and removing undesirable impulsive artifacts that degrade audio quality without contributing meaningful acoustic content. Audio recordings may contain various types of impulsive noise sources such as electrical interference, mechanical vibrations, or digital processing artifacts that manifest as brief, high-energy transient events within the audio signal. The audio processing system 102 may configure detection thresholds and clustering parameters to identify these undesirable transient events based on their spectral characteristics, temporal duration, and energy distribution patterns. The declicking process may involve targeted attenuation or removal of detected artifact transients while preserving genuine acoustic transients that contribute to the musical or speech content of the audio signal. The selective processing approach enables restoration of degraded audio recordings without compromising the natural transient characteristics that define the acoustic character of the original sound sources.

The declicking implementation may incorporate spectral analysis techniques that distinguish between genuine acoustic transients and artifact transients based on their frequency domain characteristics and temporal behavior patterns. Genuine acoustic transients typically exhibit coherent spectral structures that reflect the physical properties of sound-producing mechanisms, while artifact transients often display irregular or unnatural spectral patterns that indicate non-acoustic origins. The audio processing system 102 may analyze the spectral coherence, temporal evolution, and energy distribution characteristics of detected transients to classify them as either genuine acoustic events or undesirable artifacts. The classification process may involve machine learning algorithms, statistical analysis techniques, or rule-based decision systems that automatically identify artifact transients for removal while preserving acoustically relevant transient content. The automated declicking capability enables efficient restoration of large audio archives or real-time processing of audio signals in broadcast or streaming applications.

Denoising applications may leverage the transient detection and clustering capabilities to remove unwanted noise components while preserving both transient and sinusoidal elements that contribute to the desired audio content. Audio signals often contain mixtures of desired acoustic content and unwanted noise sources that occupy overlapping frequency regions, making selective noise removal challenging using conventional frequency domain filtering techniques. The disclosed approach enables identification of noise-like spectral components based on their asynchronous instantaneous frequency behavior and lack of coherent spectral structure, distinguishing them from both sinusoidal components and genuine acoustic transients. The audio processing system 102 may apply targeted attenuation to detected noise components while preserving the spectral content associated with transient clusters and sinusoidal peaks that represent the desired audio signal. The selective noise removal approach maintains the acoustic integrity of the desired audio content while achieving substantial noise reduction performance.

The denoising process may involve adaptive threshold adjustment that accounts for the varying characteristics of different noise types and acoustic environments encountered in audio processing applications. Background noise sources may exhibit different spectral and temporal characteristics depending on their physical origins, requiring customized detection parameters to achieve optimal noise identification performance. The audio processing system 102 may analyze the statistical properties of the audio signal to estimate noise characteristics and adjust detection thresholds accordingly, enabling automatic adaptation to different noise environments without manual parameter adjustment. In some cases, the audio processing system 102 may implement spectral subtraction techniques that estimate the noise spectrum during periods of low signal activity and subtract the estimated noise contribution from the overall spectral content. The combination of transient-preserving noise detection with adaptive spectral subtraction enables comprehensive noise reduction that maintains the natural acoustic characteristics of the desired audio signal.

Audio morphing applications may utilize the transient detection and clustering capabilities to enable sophisticated audio transformation operations that blend or transition between different audio signals while preserving the characteristic features of each source. Audio morphing involves creating smooth transitions between different acoustic textures, timbres, or sound sources by interpolating between their spectral characteristics in a perceptually meaningful manner. The separate identification of transient and sinusoidal components within each source audio signal enables targeted morphing operations that may blend sinusoidal components independently from transient components, creating more natural and musically coherent morphing effects. The audio processing system 102 may apply different interpolation strategies to transient clusters compared to sinusoidal peaks, accounting for the different perceptual and acoustic properties of these distinct signal types during the morphing process.

The morphing implementation may involve temporal alignment of transient events between source audio signals to ensure coherent blending of percussive and rhythmic elements during the transformation process. The audio processing system 102 may analyze the temporal distribution of transient clusters in each source signal and apply time warping or temporal alignment operations that synchronize related transient events across the morphing transition. The aligned transient events may then undergo spectral interpolation that blends their frequency domain characteristics while preserving the temporal coherence and acoustic impact of the percussive elements. The sinusoidal components may undergo separate spectral interpolation that focuses on smooth transitions between tonal characteristics, harmonic structures, and formant patterns that define the timbral qualities of the source audio signals. The independent processing of transient and sinusoidal components during morphing operations enables creation of hybrid audio textures that combine elements from multiple source signals in musically meaningful ways that would be difficult to achieve using conventional morphing techniques that treat all spectral content uniformly.

FIG. 7 illustrates a block diagram of an example computer system suitable for use in embodiments disclosed herein in accordance with an embodiment of the disclosure. For example, the audio processing system 102 may include or utilize one or several computing systems 700, and the processor 114 and memory 116 may be located at one or several computing systems 700. In various implementations, the user device 106 and/or additional user devices may be implemented using any number of computing devices including, but not limited to a computer, laptop, tablet, mobile phone, smart phone, wearable device (e.g., AR/VR headset, smartwatch, smart glasses, or the like), smart speaker, vehicle (e.g., automobile), or appliance.

This disclosure contemplates any suitable number of computing systems 700. For example, the computing system 700 may be a server, a desktop computing system, a mainframe, a mesh of computing systems, a laptop or notebook computing system, a tablet computing system, an embedded computer system, a system-on-chip, a single-board computing system, or a combination of two or more of these. Where appropriate, the computing system 700 may include one or more computing systems; be unitary or distributed; span multiple locations; span multiple machines; span multiple data centers; or reside in a cloud, which may include one or more cloud components in one or more networks. The computing system 700 may include one or more processors 702, an input/output I/O interface 704, one or more external devices 706, one or more memory components 708, a network interface 710 and one or more displays 712. Each of the various components may be in communication with one another through one or more buses or communication networks, such as wired or wireless networks.

In some embodiments, various components of the computing system 700 may communicate with one another through the network 104. For example, in some embodiments, the computing system 700 may be implemented as a serverless service, where computing resources for various components of the computing system 700 may be located across various computing environments (e.g., cloud platforms) and may be reallocated dynamically and/or automatically according to, for example resource usage of the computing system 700. In various implementations, the computing system 700 may be implemented using organizational processing constructs such as functions implemented by worker elements allocated with compute resources, containers, virtual machines, and the like.

The processor 702 may be any type of electronic device capable of processing, receiving, and/or transmitting instructions. For example, the processor 702 may be a central processing unit, graphics processing unit, microprocessor, processor, or microcontroller. Additionally, it should be noted that some components of the computing system 700 may be controlled by a first processor and other components may be controlled by a second processor, where the first and second processors may or may not be in communication with each other. The audio processing system 102 and user device 106 may perform operations by executing executable instructions (e.g., software) using the processor 702. The processor 702 may be used to implement the processor 114 as shown in FIG. 1.

The I/O interface 704 allows a user to enter data in to computing system 700, as well as provides an input/output for the computing system 700 to communicate with other devices or services. The I/O interface 704 can include one or more input buttons, touch pads, and so on.

The external devices 706 are one or more devices that can be used to provide various inputs to the computing system 700, e.g., mouse, microphone, keyboard, trackpad, or the like. The external devices 706 may be local or remote and may vary as desired. In some examples, the external devices 706 may also include one or more additional sensors.

The memory components 708 are used by the computing system 700 to store instructions for the processor 114 and may be implemented as a data store and the like. The memory components 708 may be, for example, magneto-optical storage, read-only memory, random access memory, erasable programmable memory, flash memory, or a combination of one or more types of memory components. The memory components 708 may be used to implement the memory 116 as shown in FIG. 1. The memory 116 may include various instructions for various functions of the audio processing system 102 which, when executed by the processor 114, perform various functions of the audio processing system 102. The memory 116 may further store data and/or instructions for retrieving data used by the audio processing system 102. Similar to the processor 702, the memory components 708 utilized by the audio processing system 102 may be distributed across various physical computing devices. In some examples, the memory components 708 may access instructions and/or data from other devices or locations, and such instructions and/or data may be read into the memory 116 to implement the audio processing system 102.

The network interface 710 provides communication to and from the computing system 700 to other devices. The network interface 710 includes one or more communication protocols, such as, but not limited to WI-FI®, Ethernet, BLUETOOTH®, and so on. The network interface 710 may also include one or more hardwired components, such as a Universal Serial Bus (USB) cable, or the like. The configuration of the network interface 710 depends on the types of communication desired and may be modified to communicate via WIFI®, BLUETOOTH®, and so on.

The network interface 710 may interface with the network 104. The network 104 may be implemented using one or more wired and/or wireless systems and protocols for communications between computing devices. In various embodiments, the network 104 or various portions of the network 104 may be implemented using the internet, a local area network, a wide area network, and/or other networks. In addition to traditional data networking protocols, in some embodiments, data may be communicated according to protocols and/or standards including near field communication, Bluetooth®, Wi-Fi, cellular connections, or the like.

The display 712 provides a visual output for the computing devices and may be varied as needed based on the device. The display 712 may be configured to provide visual feedback to the user and may include a liquid crystal display screen, light emitting diode screen, plasma screen, or the like. In some examples, the display 712 may be configured to act as an input element for the user through touch feedback or the like.

The components in FIG. 7 are exemplary only. In various examples, the computing system 700 may include additional components and/or functionality not shown in FIG. 7.

Accordingly, the audio processing system 102 described herein addresses particular challenges and needs presented by systems for detecting audio transients and audio processing applications that benefit from separate treatment of transient and sinusoidal spectral components. The audio processing system 102 leverages phase-based transient detection capabilities and clustering algorithms to achieve processing objectives that would be difficult or impossible using conventional frequency domain techniques that treat all spectral content uniformly. The ability to distinguish between transient and sinusoidal components within frequency domain representations provides the foundation for targeted processing approaches that preserve the acoustic characteristics of different signal types while enabling sophisticated audio manipulation operations.

The technology described herein may be implemented as logical operations and/or modules in one or more systems. The logical operations may be implemented as a sequence of processor-implemented steps directed by software programs executing in one or more computer systems and as interconnected machine or circuit modules within one or more computer systems, or as a combination of both. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

The description of certain embodiments included herein is merely exemplary in nature and is in no way intended to limit the scope of the disclosure or its applications or uses. In the included detailed description of embodiments of the present systems and methods, reference is made to the accompanying figures which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description therefore is not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

Although the methods described herein (e.g., method 300) depict a particular sequence of operations, the sequence may be altered without departing from the scope of the present disclosure. For example, some of the operations depicted may be performed in parallel or in a different sequence. In other examples, different components of an example device or system that implements the routine may perform functions at substantially the same time or in a specific sequence.

The particulars shown herein are by way of example and for purposes of illustrative discussion of the preferred embodiments of the present disclosure and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the figures and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

All relative, directional, and ordinal references (including top, bottom, side, front, rear, first, second, third, and so forth) are given by way of example to aid the reader's understanding of the examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and Intended spirit and scope of the present system as set forth in the claims that follow. Accordingly, the specification and figures are to be regarded in an illustrative manner and are not intended to limit the scope of the appended claims.

What is claimed is:

1. A computer-implemented method for processing audio transients, comprising:
performing, via a processor, a Short-Term Fourier Transform (STFT) on audio data to generate a frequency-domain representation of the audio data, the frequency domain representation comprising:
an audio frame defining a time range in the audio data; and
a first frequency bin in the audio frame, wherein the first frequency bin defines a first frequency range of the audio data in the audio frame;
determining, via the processor, a first instantaneous frequency of the first frequency bin;
determining, via the processor, a first audio transient by comparing the first instantaneous frequency with one or more instantaneous frequencies of one or more frequency bins to determine that the first instantaneous frequency is asynchronous with the one or more instantaneous frequencies;
clustering, via the processor, the first audio transient with one or more audio transients of the audio data; and
processing, via the processor, the cluster of audio transients.

2. The method of claim 1, wherein determining the first audio transient further comprises determining a change in an amplitude magnitude, wherein the change in magnitude exceeds a threshold magnitude value.

3. The method of claim 2, wherein the change in amplitude magnitude is calculated based on an Energy Difference formula that compares spectral energy between consecutive audio frames.

4. The method of claim 1, wherein comparing the first instantaneous frequency with one or more instantaneous frequencies of one or more frequency bins to determine that the first instantaneous frequency is asynchronous with the one or more instantaneous frequencies comprises determining the first instantaneous frequency and the one or more instantaneous frequencies do not synchronize to a sinusoidal frequency.

5. The method of claim 1, wherein the one or more frequency bins are adjacent to the first frequency bin.

6. The method of claim 1, wherein determining the first instantaneous frequency comprises determining the first instantaneous frequency based on phase information from consecutive STFT analysis frames.

7. The method of claim 6, wherein determining the first instantaneous frequency based on phase information from consecutive STFT analysis frames comprises determining true frequency content within the first frequency bin based on overlap factors and frequency bin characteristics.

8. The method of claim 7, wherein determining the first instantaneous frequency further comprises:
determining the first instantaneous frequency based on expected phase advancement due to frame overlap in STFT implementation; and
applying a modulo operation to maintain phase differences within an appropriate range for frequency calculation.

9. The method of claim 1, wherein determining the first audio transient further comprises calculating a noisiness value for a spectral peak of the first frequency bin by determining a minimum absolute difference between the spectral peak of the first instantaneous frequency and each spectral peak of the one or more instantaneous frequencies of the one or more frequency bins to quantify synchronization behavior.

10. The method of claim 9, wherein determining the first audio transient further comprises combining the noisiness value with an Energy Difference measurement between consecutive analysis frames by multiplying the noisiness value by a clipped version of an absolute Energy Difference value to create a combined detection metric for determining the first audio transient.

11. The method of claim 1, wherein clustering the first audio transient with one or more audio transients comprises grouping transient components based on at least one of temporal proximity, spectral characteristics, or similarity measures.

12. The method of claim 11, wherein the similarity measures quantify relationships between different transient components based on at least one of instantaneous frequency patterns, magnitude distributions, or temporal alignment characteristics.

13. The method of claim 1, wherein processing the cluster of audio transients comprises at least one of modifying a frequency of, modifying an amplitude of, or applying a filter to each audio transient of the cluster of audio transients.

14. A computer-implemented method for detecting audio transients in frequency domain representations, comprising:
transforming, via a processor, audio data into a frequency domain representation using a Short-Time Fourier Transform to generate a plurality of frequency bins across a plurality of audio frames;
determining, via the processor, instantaneous frequencies for the plurality of frequency bins using phase information from the frequency domain representation;
determining, via the processor, a noisiness value for a spectral peak of a frequency bin of the plurality of frequency bins by determining a minimum absolute difference between instantaneous frequencies of adjacent frequency bins within the spectral peak;
determining, via the processor, that the spectral peak contains a transient component when the noisiness value exceeds a threshold value;
clustering, via the processor, the transient component with other detected transient components based on spectral or temporal proximity; and
processing, via the processor, the cluster of transient components.

15. The method of claim 14, wherein determining the noisiness value comprises selecting a minimum absolute difference between the instantaneous frequency of a frequency bin corresponding to a magnitude maximum within the spectral peak and instantaneous frequencies of immediately adjacent frequency bins.

16. The method of claim 15, wherein the threshold value is a frequency dependent threshold that varies based on spectral characteristics and psychoacoustic properties of different frequency regions within an audio spectrum.

17. The method of claim 14, further comprising combining the noisiness value with an Energy Difference measurement between consecutive audio frames to create a combined detection metric for identifying transient components.

18. The method of claim 17, wherein creating the combined detection metric comprises multiplying the noisiness value by a clipped version of an absolute Energy Difference value to prevent overrepresentation of energy-based detection factors.

19. An audio processing system, comprising:
a processor; and
memory storing instructions that, when executed by the processor, cause the processor to:
perform a Short-Time Fourier Transform on audio data to generate frequency bins within audio frames;
calculate instantaneous frequencies for the frequency bins using phase differences between consecutive audio frames;
identify transient components by detecting asynchronous behavior in the instantaneous frequencies across adjacent frequency bins;
cluster the identified transient components into groups based on similarity criteria; and
apply targeted processing operations to the clustered transient components separately from non-transient spectral content.

20. The audio processing system of claim 19, wherein identifying transient components further comprises:
determining an Energy Difference measurement between the consecutive audio frames; and
identifying the transient components based on the Energy Difference measurement.
